(19) United States
(12) Patent Application Publication
(10) Pub. No.: US 2009/0026934 A1
(43) Pub. Date: Jan. 29, 2009

(54) ADHESIVE ENCAPSULATING COMPOSITION FILM AND ORGANIC ELECTROLUMINESCENCE DEVICE

(76) Inventors: Jun Fujita, Tokyo (JP); Takashi Yamasaki, Kanagawa (JP); Hideki Minami, Tokyo (JP); Nami Kobori, Kanagawa (JP)

Correspondence Address: 3M INNOVATIVE PROPERTIES COMPANY, PO BOX 33427, ST. PAUL, MN, 55133-3427, US

(21) Appl. No.: 12/161,039

(22) PCT Filed: Jan. 23, 2007
(86) PCT No.: PCT/US2007/001724

§ 371 Date: Sep. 29, 2008

(30) Foreign Application Priority Data
Jan. 24, 2006 (JP) 2006-015334

(51) Int. Cl. H01J 1/62; C08F 10/00; B32B 27/08; C08L 23/00

(52) U.S. Cl. 313/504; 525/191; 524/525; 428/517; 522/158

(57) ABSTRACT

An adhesive encapsulating composition and an encapsulating film, which are useful as an encapsulant for an organic electroluminescence device or other electronic devices is provided. The adhesive encapsulating composition includes a hydrogenated cyclic olefin-based polymer and a polyisobutylene resin having a weight average molecular weight of 500,000 or more. Some embodiments of the adhesive encapsulating•composition include a hydrogenated cyclic olefin-based polymer, a polyisobutylene resin having a weight average molecular weight of 500,000 or more, a photocurable resin, and a photopolymerization initiator.

### CROSS REFERENCE TO RELATED APPLICATIONS

This application claims priority to Japanese patent application no. 2006-15334, filed Jan. 24, 2006, the disclosure of which is incorporated by reference herein in its entirety.

### FIELD

An encapsulating or sealing composition having adhesive properties for use in an electronic device is disclosed. More specifically, an adhesive encapsulating composition and an encapsulating film, which can be used as an encapsulant for a display device such as an organic electroluminescent device is disclosed.

### BACKGROUND

Organic electroluminescence (referred to hereafter as “EL”) devices include an organic layer (hereinafter sometimes referred to as a “light-emitting unit”) provided by stacking an organic charge transport layer and an organic light-emitting layer between an anode and a cathode. EL devices often can provide high-intensity light emission while being driven by direct current and low-voltage. EL devices have all constituent elements formed of a solid material and have the potential for being used as flexible displays.

The performance of some EL devices can deteriorate over time. For example, light emission characteristics such as light emission intensity, light emission efficiency and light emission uniformity can decrease over time. The deterioration of the light emission characteristics can be caused by oxidation of the electrode due to oxygen permeating into the organic EL device, oxidative decomposition of the organic material due to generation of heat from driving the device, oxidation of the electrode due to moisture in the air that permeates into the organic EL device, or breakdown of the organic material. Furthermore, interfacial separation of the structure may also give rise to deterioration of the light emission characteristics. The interfacial separation can result, for example, from the effects of oxygen or moisture and from the effects of heat generation while driving the device. Heat can trigger interfacial separation due to the generation of stress resulting from differences in the thermal expansion coefficients between adjacent layers.

In order to prevent these problems, a technique of encapsulating the organic EL device to protect the device from moisture and oxygen contact has been utilized. For example, Japanese Unexamined Patent Publication (Kokai) No. 5-182759 describes a technique of covering an organic EL layer formed on a glass substrate with a photocurable resin having moisture resistance and, at the same time, fixing a substrate having low water permeability on top of the photocurable resin layer. Japanese Kokai No. 10-74583 describes a technique of encapsulating opposing transparent substrates with a sealing material comprising frit glass. Japanese Kokai No. 10-233283 describes a technique of bonding a substrate and a shield member with a cation curing-type ultraviolet-curable epoxy resin adhesive with the formation of an airtight space there between. Japanese Kokai No. 2001-85155 describes a technique of bonding a substrate and an airtight shielding material using a photocurable resin composition. The resin composition contains an epoxy compound having two or more epoxy groups within one molecule, a photocationic curing initiator, and an inorganic filler. Japanese Kokai No. 2004-111380 describes a technique for preventing generation of a non-light-emitting portion (referred to as a “dark spot”) resulting from intrusion of moisture into the organic EL device. An epoxy resin having a softening point of 50° C. or more with a specific structure is used as the encapsulant of the organic EL device. Also, Japanese Kokai No. 5-101884 describes a technique of covering the outer surface of an organic EL device with an encapsulating film comprising a moisture-proof polymer film and an adhesive layer.

However, the resin adhesives used as the encapsulant in the above techniques are still insufficient because of their hermetic sealing properties, moisture resistance, moisture barrier properties, and the like. The organic light-emitting layer or charge transfer layer can be thermally deteriorated due to heating in the encapsulation step or the light-emitting characteristics can be deteriorated due to crystallization. Furthermore, when a photocurable resin adhesive is used, the organic light-emitting layer and the charge transfer layer can be deteriorated because of the large dose of ultraviolet irradiation necessary for curing. In addition, after the encapsulant is cured, it can readily be cracked due to impact or vibrations which may occur when the product is used. Cracks in the encapsulant can lead, at least in some cases, to deterioration of the performance characteristics of the device.

Japanese Kokai No. 9-148066 describes a technique of preparing an airtight container for housing an organic EL device. A drying means is used that is capable of chemically absorbing moisture and maintaining the solid state even after moisture absorption. However, even when such drying means are used, moisture that permeates into the container from the outside or moisture contained in the encapsulant (adhesive) used for the formation of the airtight container can cause deterioration.

### SUMMARY

An organic EL device using an adhesive encapsulating composition is disclosed. More specifically, an organic EL device that includes a pair of opposing electrodes, a light-emitting unit having at least an organic light-emitting layer, which is disposed between the electrodes, and an adhesive film comprising an adhesive encapsulating composition which is disposed on, above, or around the light-emitting unit is provided.

Provided herein is an adhesive encapsulating composition useful as an encapsulant for an organic EL device or other electronic devices. The encapsulant can minimize deterioration of the EL device due to oxygen or moisture permeating from outside the device or due to oxygen or moisture originating in the encapsulant. The adhesive encapsulating composition provided herein does not require high-temperature heating or other similar processes in the encapsulation step and can protect the device from impacts or vibrations. Encapsulating films using the composition are also provided.

Also provided herein is an adhesive encapsulating composition with improved handleability and enhanced characteristics as an encapsulant.

An organic EL device is also provided that minimizes deterioration of the performance characteristics because of the encapsulant.

An adhesive encapsulating or sealing composition for use in an electronic device that includes a hydrogenated cyclic olefin-based polymer and a polyisobutylene resin having a weight average molecular weight of 500,000 g/mole or more is also disclosed.

An adhesive encapsulating or sealing composition for use in electronic devices that includes a hydrogenated cyclic olefin-based polymer, a polyisobutylene resin having a weight average molecular weight of 500,000 g/mole or more, a photocurable resin, and a photopolymerization initiator is also disclosed.

An encapsulating film that includes an adhesive film comprising an adhesive encapsulating composition and a backing lined with the adhesive film is also provided.

### BRIEF DESCRIPTION OF THE DRAWINGS

FIG. 1 shows a cross-sectional view of one embodiment of the encapsulating film.

FIG. 2 shows a cross-sectional view of one embodiment of an organic EL device.

FIG. 3 shows a cross-sectional view of another embodiment of an organic EL device.

FIG. 4 shows a cross-sectional view of yet another embodiment of an organic EL device.

### DETAILED DESCRIPTION

As will be understood from the detailed description below, the adhesive encapsulating composition or sealing composition usually is transparent, has a low permeability to moisture, and has adhesive properties. The adhesive encapsulating composition can be advantageously used as an encapsulant in an organic EL device or other electronic devices. One embodiment of the adhesive encapsulating composition includes a hydrogenated cyclic olefin-based polymer and a polyisobutylene resin.

The hydrogenated cyclic olefin-based polymer used in the adhesive encapsulating composition impacts the adhesive properties and decreases moisture permeability. Furthermore, the polyisobutylene resin, which has a weight average molecular weight of at least 500,000 g/mole, contributes to the heat resistance and the sufficiently high strength. The polyisobutylene resin also contributes to the low surface energy of the adhesive encapsulating composition. A low surface energy allows for easy spreading of the adhesive encapsulating composition on an adherent, specifically, a substrate or a laminate, and minimizes the generation of voids at the interface. Also, since an acid is not included in the adhesive encapsulating composition, there is less concern about corrosion of the electrode in the EL device. In addition, the adhesive encapsulating composition itself contains no moisture. The lack of moisture in the adhesive encapsulating composition minimizes the adverse effects of moisture on the EL device. Moreover, the adhesive encapsulating composition is transparent in the visible region of the spectrum and can be disposed on the side of the light-emitting surface or the light-receiving surface without blocking light. Furthermore, the adhesive encapsulating composition can be used in flexible displays and the generation of encapsulation defects due to impact or vibration can be minimized.

Because the adhesive encapsulating composition does not require high-temperature heating or other similar processes in the encapsulation or sealing step, the adverse effects associated with such steps can be minimized.

The handleability of the adhesive encapsulating composition can be improved by combining it with a backing to form an encapsulating film.

In addition, an organic EL device that retains important performance characteristics over time is provided. The organic EL device includes an encapsulant or sealing agent. The devices are easy to produce and can have reduced size and weight.

An adhesive encapsulating or sealing composition is provided that includes a hydrogenated cyclic olefin-based polymer, and a polyisobutylene resin having a weight average molecular weight of 500,000 g/mole or more.

The first component, which is the cyclic olefin-based polymer is generally a resin with low moisture permeability and can impact the adhesive properties of the polyisobutylene resin. Specifically, the cyclic olefin-based polymer can include, for example, hydrogenated petroleum resin obtained by hydrogenating a petroleum resin such as a tackifier. The hydrogenated petroleum resin can include a partially hydrogenated resin, a completely hydrogenated resin, or a combination thereof. The partially hydrogenated resin can have any hydrogenation ratio. In one embodiment, a completely hydrogenated resin is desirable because of its low moisture permeability and compatibility with the polyisobutylene resin.

Specific examples of the cyclic olefin-based polymer include, but are not limited to a hydrogenated terpene-based resin (for example, resins commercially available under the trade designation CLEARON P, M and K (Yasuhara Chemical)); a hydrogenated resin or hydrogenated ester-based resin (for example, resins commercially available under the trade designation FORAL AX (Hercules Inc.), FORAL 105 (Hercules Inc.), PENCEL A (Arakawa Chemical Industries. Co., Ltd.), ESTERGUM H (Arakawa Chemical Industries Co., Ltd.), and SUPER ESTER A (Arakawa Chemical Industries. Co., Ltd.); a disproportionate resin or disproportionate ester-based resin (for example, resin commercially available under the trade designation PINECRYSTAL (Arakawa Chemical Industries Co., Ltd.); a hydrogenated dicyclopentadiene-based resin which is a hydrogenated resin of a C5-type petroleum resin obtained by copolymerizing a C5 fraction such as pentene, isoprene, piperine and 1,3-pentadiene produced through thermal decomposition of petroleum naphtha (for example, resins commercially available under the trade designations ESCOREZ 5300 (Exxon Chemical Co.), ESCOREZ 5400 (Exxon Chemical Co.), and EASTOTAC H (Eastman Chemical Co.)); a partially hydrogenated aromatic modified dicyclopentadiene-based resin (for example, resin commercially available under the trade designation ESCOREZ 5600 (Exxon Chemical Co.)); a resin resulting from hydrogenation of a C9-type petroleum resin obtained by copolymerizing a C9 fraction such as indene, vinyltoluene and α- or β-methylstyrene produced by thermal decomposition of petroleum naphtha (for example, resins commercially available under the trade designation ARCON P or ARCON M (Arakawa Chemical Industries Co., Ltd.)); and a resin resulting from hydrogenation of a copolymerized petroleum resin of the above-described C5 fraction and C9 fraction (for example, resin commercially available under the trade designation IMARV (Idemitsu Petrochemical Co.)). In one embodiment, the cyclic olefin-based polymer is a hydrogenated dicyclopentadiene-based resin because of its low moisture permeability and transparency.

The cyclic olefin-based polymer has a softening temperature (ring and ball softening temperature) that may vary, depending at least in part, upon the adhesion of the composition, the temperature utilized, the ease of production, and the like. The ring and ball softening temperature can generally be from about 50 to 200° C. In one embodiment, the ring and ball softening temperature is from about 80 to 150° C. If the ring and ball softening temperature is less than 80° C., the saturated cyclic olefin-based polymer may undergo separation and liquefaction due to heat generated upon the emission of light. This can cause deterioration of an organic layer such as a light-emitting layer when an organic EL device is encapsulated directly with an adhesive encapsulating composition. On the other hand, if the ring and ball softening point exceeds 150° C., the amount of the polymer added is so low that satisfactory improvement of relevant characteristics may not be obtained.

Cyclic olefin-based polymers that can be utilized in adhesive encapsulating compositions typically have a weight average molecular weight from about 200 to 5,000 g/mole. In another embodiment, the weight average molecular weight of the cyclic olefin-based polymer is from about 500 to 3,000 g/mole. If the weight average molecular weight exceeds 5,000 g/mole, poor tackification may result or the compatibility with the polyisobutylene-based resin may decrease.

In an adhesive encapsulating composition, the cyclic olefin-based polymer can be blended with the polyisobutylene resin at various ratios. Generally, about 20 to 90 wt % cyclic olefin-based polymer is blended with about 10 to 80 wt % polyisobutylene resin. In another embodiment, about 20 to 70 wt % cyclic olefin-based polymer is blended with about 30 to 80 wt % polyisobutylene resin.

The second component, which is the polyisobutylene resin, is generally a resin having a polyisobutylene skeleton in the main or a side chain. Fundamentally, such a polyisobutylene resin can be prepared by polymerizing isobutylene alone or a combination of isobutylene and n-butene, isoprene, or butadiene in the presence of a Lewis acid catalyst such as aluminum chloride or boron trifluoride. Suitable polyisobutylene resins are commercially available under the trade designation VISTANEX (Exxon Chemical Co.), HYCAR (Goodrich Corp.), OPANOL (BASF AG), and JSR BUTYL (Japan Butyl Co., Ltd.).

The polyisobutylene resin generally has a solubility parameter (SP value), which is an index for characterizing the polarity of a compound; that is similar to that of the cyclic olefin-based polymer (the first component) and exhibits good compatibility (i.e., miscibility) with the cyclic olefin-based polymer so that a transparent film can be formed. Also, as compared with many aromatic ring-containing organic compounds used for the light-emitting layer or the charge transfer layer of an organic EL device, this resin generally has lower polarity and higher viscosity. Even when the organic EL device is in contact with the encapsulant, its constituent elements typically are not attacked. Furthermore, the polyisobutylene resin has a low surface energy and therefore, when this resin is used in a viscous adhesive encapsulating composition, the adhesive is readily spread onto an adherent and the generation of voids at the interface is minimized. In addition, the glass transition temperature and the moisture permeability are low and therefore, the polyisobutylene resin is suitable as the base resin of the adhesive encapsulating composition.

The polyisobutylene resin usually has a weight average molecular weight polystyrene-reduced molecular weight by GPC) of about 300,000 g/mole or more. In another embodiment, the polyisobutylene resin often has a weight average molecular weight of about 500,000 g/mole or more. With a higher molecular weight, the adhesive encapsulating composition that is prepared can have a wide rubber plateau region and can maintain sufficiently high heat resistance and peel strength.

The polyisobutylene resin may have various viscosities according to the formulation of the adhesive encapsulating composition. When defined by the viscosity as measured by intrinsic viscosity at 20° C. in diisobutylene, the polyisobutylene resin usually has a viscosity average molecular weight of about 100,000 to 10,000,000 g/mole or about 500,000 to 5,000,000 g/mole.

Another embodiment includes an adhesive encapsulating composition that includes a hydrogenated cyclic olefin-based polymer, a polyisobutylene resin, a photocurable resin, and a photopolymerization initiator. The hydrogenated cyclic olefin-based polymer, and the polyisobutylene resin are as discussed above.

The photocurable resin can enhance the fluidity of an adhesive encapsulating composition before it is cured, and can enhance the wettability of the composition for the adherent. Embodiments that include a photocurable resin can increase the adhesion and retention strength of the adhesive encapsulating composition because of the curing of the resin.

The photocurable resin can be saturated or unsaturated and can be aliphatic, alicyclic, aromatic or heterocyclic. In some embodiments, saturated long-chain alkyl (meth)acrylates, cycloaliphatic (meth)acrylates, epoxy resins, or combinations thereof can be utilized because they can enhance the miscibility of the hydrogenated cyclic aliphatic hydrocarbon resin and the polyisobutylene. The resins can be unsubstituted or substituted with various groups such as hydroxy or alkoxy groups.

Exemplary long chain alkyl (meth)acrylate photocurable resins include, but are not limited to, octyl (meth)acrylate, stearyl (meth)acrylate, 1,9-nonandiol di(meth) acrylate, 1,10-decandiol di(meth)acrylate, and hydrogenated polybutadiene di(meth) acrylate resin. Exemplary cycloaliphatic (meth)acrylate photocurable resins include, but are not limited to, isobornyl (meth)acrylate, tetramethylpiperidiyl methacrylate, pentamethylpiperidiyl methacrylate, dicyclopentanyl (meth)acrylate, dicyclopentenyl (meth)acrylate, tri-cyclodecanediol di(meth)acrylate, and tri-cyclodecane di-methanol di(meth)acrylate. Exemplary epoxy photocurable resins include, but are not limited to, epoxidized linseed oil, epoxidized polybutadiene, polyisobutene oxide, α-pinene oxide, limonene dioxide, 3,4-epoxycyclohexylmethyl-3,4-epoxycyclohexane carboxylate, tri-cyclodecane di-methanol diglycidyl ether, hydrogenated bisphenol A diglycidyl ether, and 1,2-bis[(3-ethyl-3oxthethanylmethoxy)methyl]benzene.

In some embodiments, photocurable resins that contain more than one curable group are utilized. It will also be understood by one of skill in the art that mixtures of photocurable resins can be utilized.

Generally, photocurable resins are present in adhesive encapsulating compositions in amounts from 5 weight % to 50 weight %. In some embodiments, if the photocurable resin is present in an amount less than 5 weight %, the composition does not provide enough adhesion and retention strength. In some embodiments, if the photocurable resin is present in an amount greater than 50 weight %, the moisture permeability or flexibility of the final adhesive encapsulating layer can be low. If a low moisture permeability is particularly desired, the photocurable resin can generally be present in an amount from 5 weight % to 20 weight %. Such low amounts can be desirable in such situations because the photocurable resins generally have higher moisture permeability than hydrogenated cyclic olefin-based polymers or polyisobutylene resins.

In embodiments that include a photopolymerization initiator, generally, either photo radical initiators or cationic initiators can be utilized. Generally, the choice of initiator will depend at least in part on the particular photocurable resin that is included in the adhesive encapsulating composition.

Exemplary photo radical initiators include, but are not limited to, acetophenone, diethoxyacetophenone, 2-[4-(methylthio)-methyl-1-phenyl]-2-morphorino propanone, benzoin, benzoin ethyl ether, benzylmethyl ketal, benzophenone, benzylmethylbenzoyl formate, 2-ethylanthraquinone, thioxanthone, diethylthioxanthone, 2,4,6-trimethylbenzoyl diphenylphosphine oxide (commercially available under the trade designation LUCIRIN TPO from BASF AG), 2,4,6-trimethylbenzoyl diphenylethoxyphosphine oxide (commercially available under the trade designation LUCIRIN TPO-L from BASF AG), bis(2,4,6-trimethyl benzoyl) phenyl phosphine oxide (commercially available under the trade designation IRGACURE 819 from Ciba-Geigy Co.), 2-hydroxy-2-methyl-1-phenyl propane-1-one (commercially available under the trade designation DAROCURE 1173 from Ciba-Geigy Co.), 4-(2-hydroxyethoxy)phenyl (2-hydroxy-2-propyl) ketone (commercially available under the trade designation IRGACURE 2959 from Ciba-Geigy Co.), 4-(2-acrylyloxyethoxy)phenyl-(2-hydroxy-2-propyl) ketone, 1-hydroxycyclohexyl phenyl ketone (commercially available under the trade designation IRGACURE 184 from Ciba-Geigy Co.), 1-(4-isopropylphenyl)-2-hydroxy-2-methylpropane-1-one, 1-(4-dodecylphenyl)-2-hydroxy-2-methylpropane-1-one, 2-methyl-2-morphorino(4-thiomethylphenyl)propane-1-one (commercially available under the trade designation IRGACURE 907 from Ciba-Geigy Co.), 2-benzil-2-dimethylamino-1-(4-morpholinophenyl)-butanone (commercially available under the trade designation IRGACURE 369 from Ciba-Geigy Co.), N,N′-octamethylene bis acridine (commercially available under the trade designation ADEKA OPTOMER N1717 from ADEKA Corp.), and acryloyl benzophenone (commercially available under the trade designation EBERCRYL P36 from UCB Chemicals Co., Ltd.).

In one embodiment, onium salts, can be utilized because of their low level of metal ion contamination. Onium salts include, but are not limited to, iodonium, sulfonium and phosphonium complex salts. Generally useful onium salts can be of the general formula

Y⁺X⁻. Y can include aryldialkylsulfonium, alkyldiarylsulfonium, triarylsulfonium, diaryliodonium and tetraaryl phosphonium cations, where each alkyl and aryl group can be substituted. X can include PF₆⁻, SbF₆⁻, CF₃SO₃⁻.(CF₃SO₂)₂N⁻, (CF₃SO₂)₃C⁻, (C₆F₅)₄B⁻ anions.

Examples of photo cationic initiators include, but are not limited to, those commercially available under the trade designation UVI-6990 or UVI-6974 from Union Carbide Corp., SP-150 or SP-170 from ADEKA Corp., SI-180 or SI-110 Sanshin Chemical Co., KI-85 from Degussa AG, PHOTOINITIATOR 2074 from Rodia Inc., and CI-2734, CI-2855, CI-2823, or CI-2758 from Nippon Soda Co., Ltd.

It will also be understood by one of skill in the art that mixtures of photopolymerization initiators can be utilized.

Generally, the photopolymerization initiator is present in an amount from 0.01 weight % to 5 weight % based on the weight of the adhesive encapsulating composition. In some embodiments where the amount of photopolymerization initiator is less than 0.01 weight %, the curing of the adhesive encapsulating composition is slower than desired. In some embodiments where the amount of photopolymerization initiator is greater than 5 weight %, the amount of out gassing from the adhesive encapsulating composition is higher than desired.

In addition to the above-described components, the adhesive encapsulating composition may also contain optional additives. For example, the adhesive encapsulating composition may contain a softening agent. The softening agent can be useful, for example, to adjust the composition viscosity to improve the processability (for example, making the composition suitable for extrusion), to enhance the initial adhesion at low temperatures due to a reduction in the glass transition temperature of the composition, or to provide an acceptable balance between the cohesion and adhesion. In one embodiment, the softening agent is selected to have low volatility, to be transparent, and to be free of coloration and/or odor.

Examples of softening agents that can be utilized include, but are not limited to, a petroleum-based hydrocarbon such as an aromatic type, paraffin type and naphthene type; a liquid rubber or a derivative thereof, such as liquid polyisobutylene, liquid polybutene and hydrogenated liquid polyisoprene; petrolatum; and petroleum-based asphalts. In embodiments where softening agents are utilized, one softening agent or a combination of softening agents may be used.

Specific examples of softening agents include; but are not limited to, those commercially available under the trade designation NAPVIS (BP Chemicals), CALSOL 5120 (naphthene-based oil, Calumet Lubricants Co.), KAYDOL (paraffin-based, white mineral oil, Witco Co.), TETRAX (Nippon Oil Co.), PARAPOL 1300 (Exxon Chemical Co.), and INDOPOL H-300 (BPO Amoco Co.). Other specific examples of softening agents include other polyisobutylene homopolymers, polybutylene such as material commercially available from Idemitsu Kosan Co., Ltd., polybutene such as material commercially available from Nihon Yushi Co., Ltd., and other liquid polybutene polymers. Still other specific examples of softening agents include those commercially available under the trade designation ESCOREZ 2520 (liquid aromatic petroleum hydrocarbon resin, Exxon Chemical Co.), REGALREZ 1018 (liquid hydrogenated aromatic hydrocarbon resin, Hercules Inc.), and SYLVATAC 5N (liquid resin of modified rosin ester, Arizona Chemical Co.).

In one embodiment, the softening agent is a saturated hydrocarbon compound. In another embodiment, the softening agent is liquid polyisobutylene or liquid polybutene. Polyisobutylene and polybutene having a carbon-carbon double bond at the terminal and a modified polyisobutylene can be utilized. A modified polyisobutylene has a double bond that has been modified by hydrogenation, maleination, epoxidation, amination, or similar methods.

Because of the direct encapsulation of an organic EL device with an adhesive encapsulating composition, a softening agent having a relatively high viscosity can be utilized to prevent the softening agent from separating from the adhesive encapsulating composition and permeating into the interface between the electrode and the light-emitting layer. For example, a softening agent having a kinematic viscosity of 500 to 5,000,000 mm²/s at 100° C. can be used. In another embodiment a softening agent having a kinematic viscosity of 10,000 to 1,000,000 mm²/s can be used. The softening agent may have various molecular weights, but because of the direct encapsulation of an organic EL device with an adhesive encapsulating composition, the softening agent can have a weight average molecular weight of from about 1,000 to 500,000 g/mole. In even another embodiment, the weight average molecular weight can be from about 3,000 to 100,000 g/mole to prevent the softening agent from separating from the adhesive encapsulating composition and dissolving the organic layer such as the light-emitting layer.

The amount of the softening agent used is not generally limited but in light of the desired adhesive force, heat resistance, and rigidity of the adhesive encapsulating composition, the softening agent typically can be used in an amount of about 50 wt % or less based on the entire adhesive encapsulating composition. In another embodiment, the adhesive encapsulating composition contains from about 5 to 40 wt % softening agent. If the amount of softening agent used exceeds 50 wt %, excessive plasticization may result, which can impact the heat resistance and rigidity.

Alternatively, fillers, ultraviolet absorbent, ultraviolet stabilizer, antioxidant or stabilizer, or some combination thereof may also be added to the adhesive encapsulating composition. The amounts of these additional additives is typically chosen so that the additive or additives do not inhibit the adhesive physical properties (or other similar properties, such as the curability if it is a curable composition) of the adhesive encapsulating composition.

Examples of fillers that can be utilized include, but are not limited to, a carbonate of calcium or magnesium (for example, calcium carbonate, magnesium carbonate, and dolomite); silicate (for example, kaolin, calcined clay, pyrophyllite, bentonite, sericite, zeolite, talc, attapulgite, and wollastonite); a silicic acid (for example, diatomaceous earth, and silica); an aluminum hydroxide; palaite; a barium sulfate (for example, precipitated barium sulfate); a calcium sulfate (for example, gypsum); a calcium sulfite; a carbon black; a zinc oxide; and a titanium dioxide.

The fillers that can be utilized may have different particle diameters. For example, if it is desired to provide a transparent adhesive encapsulating composition, an average primary particle diameter of the fillers can be in the range of 1 to 100 nm. In another embodiment, the filler can have an average primary particle diameter in the range of 5 to 50 nm. Further, when fillers in the form of plates or squamations are used to improve the low moisture permeability, their average primary particle diameter can be in the range of 0.1 to 5 μm. Moreover, in view of the dispersability of the filler in the resin, hydrophobic surface treated hydrophilic fillers can be used. Any conventional hydrophilic filler can be modified by a hydrophobic treatment. For example, the surface of the hydrophilic filler could be treated with an alkyl, aryl or aralkyl silane coupling agent containing hydrophobic groups such as n-octyltrialkoxy silane, a silyllation agent such as dimethyldichlorosilane and hexamethyldisilazane, polydimethylsiloxanes having hydroxyl terminals, higher alcohols such as stearyl alcohol, or higher aliphatic acids such as stearic acid.

Examples of silica fillers include, but are not limited to, products treated with dimethyldichlorosilane such as those commercially available under the trade designation AEROSIL-R972, R974 or R976 (Nippon Aerosil Co., Ltd.); products treated with hexamethyldisilazane such as those commercially available under the trade designation AEROSIL-RX50, NAX50, NX90, RX200 or RX300 (Nippon Aerosil Co., Ltd.); products treated with octylsilane such as those commercially available under the trade designation AEROSIL-R805 (Nippon Aerosil Co., Ltd.); products treated with dimethylsilicone oil such as those commercially available under the trade designation AEROSIL-RY50, NY50, RY200S, R202, RY200 or RY300 (Nippon Aerosil Co., Ltd.); and products commercially available under the trade designation CAB ASIL TS-720 (Cabot Co., Ltd.).

The fillers may be used alone, or in combination. In embodiments that include fillers, the amount of fillers added is generally from 0 to 20% by weight based on the total amount of the adhesive encapsulating composition.

Examples of ultraviolet absorbents that may be utilized include, but are not limited to, benzotriazole-based compounds, oxazolic acid amide-based compounds, and benzophenone-based compounds. The ultraviolet absorbents, when used, can be used in an amount from about 0.01 to 3 wt % based on the total amount of the adhesive encapsulating composition.

Examples of antioxidants that can be used include, but are not limited to, hindered phenol-based compounds and phosphoric acid ester-based compounds. Such compounds, when used, can be used in an amount from about 0.01 to 2 wt % based on the total amount of the adhesive encapsulating composition.

Examples of stabilizers that can be used include, but are not limited to, phenol-based stabilizers, hindered amine-based stabilizers, imidazole-based stabilizers, dithiocarbamate-based stabilizers, phosphorus-based stabilizers, and sulfur ester-based stabilizers. Such compounds, when utilized, can be used in an amount from about 0.01 to 3 wt % based on the total amount of the adhesive encapsulating composition.

The adhesive encapsulating composition may be prepared by various methods known to those of skill in the art. For example, the adhesive encapsulating composition can be prepared by thoroughly mixing the above-described components. For mixing the composition, an arbitrary mixer such as a kneader or an extruder may be used. The resulting composition can be used as the encapsulant or can be combined with other components to form the encapsulant.

The adhesive encapsulating composition can be used in a variety of forms. For example, the adhesive encapsulating composition can be applied directly to a device substrate or the like by using a screen printing method or similar methods to form an adhesive encapsulating layer. Alternatively, the adhesive encapsulating composition may be coated on an appropriate substrate as a film. The substrate may be temporarily used for shaping or may be integrated until use of the adhesive encapsulating composition. In either case, the surface of the substrate can be release-treated, for example, with a silicone resin. The coating process may be performed by using techniques known to those of skill in the art, for example, die coating, spin coating, doctor blade coating, calendaring, extrusion, and the like.

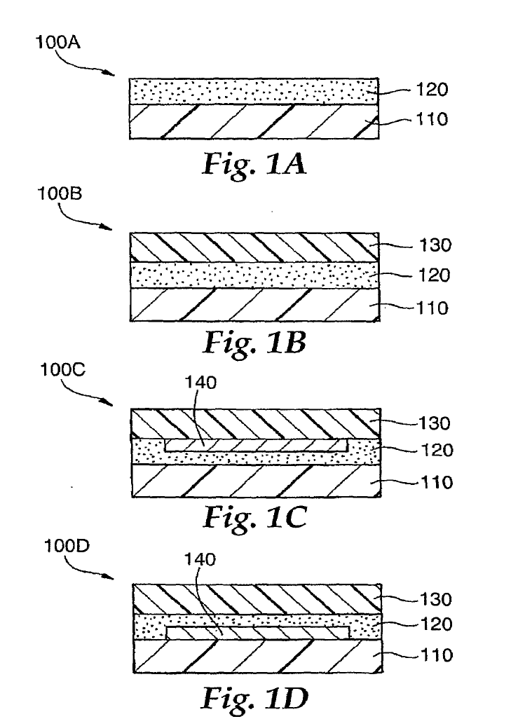

According to another method, an encapsulating film can be formed that includes a backing having an adhesive encapsulating composition film (referred to herein as an “adhesive film”) supported thereon. FIG. 1(A) shows a cross-sectional structure of an exemplary encapsulating film 100A comprising a backing 110 and an adhesive film 120. The backing 110 is a film or a sheet and includes, for example, paper, plastic film, metal foil, or a film or a sheet of other materials. Similar to the surface of the substrate described above, the backing 110 can optionally be release-treated, for example, with a silicone resin. The adhesive film 120 may be formed to have various thicknesses, but the thickness is generally from about 5 to 200 μm. In another embodiment, the thickness is from about 10 to 100 μm. In yet another embodiment, the thickness is about 25 to 100 μm. The adhesive film may be used as an encapsulant by separating it from the backing. In one embodiment, the surface of the adhesive film 120 can be protected with means such as a release liner.

Other than the structure shown in FIG. 1(A), the encapsulating film can be provided in various forms. For example, in the case where the adhesive encapsulating composition is used as an encapsulant for an electronic device, the adhesive film may be used by combining it with a constituent element of the electronic device.

For example, a gas-barrier film 130, which is used in an EL light-emitting device described later, may be provided on the adhesive film 120 as in the encapsulating film 100B shown in FIG. 1(B). The gas-barrier film 130 is a film having barrier properties to water vapor, oxygen, or both. Any suitable materials and construction can be used for the gas-barrier film 130. In some embodiments, as described later, various polymer layers with an inorganic thin film coated thereon may be used.

Also, a trapping agent 140, which is used in an EL light-emitting device described later, may be further provided as in the encapsulating film 100C or 100D shown in FIG. 1(C) or 1(D), respectively. The trapping agent 140 refers to a material that functions as a water absorbent or a desiccant and is not limited in its processing shape. In an embodiment for forming an adhesive film 120 or a laminate with a glass barrier film 130, the shape is generally a film-like or sheet-like form. Also, as shown in FIG. 1(D), in the case of disposing the trapping agent 140 between the backing 110 and the adhesive film 120, the area and shape of each layer can be adjusted such that at least a part of the adhesive film 120 directly adheres to the surface of the backing 110.

As described above, by stacking not only an adhesive film 120 but also a gas-barrier film 130, or a trapping agent 140, the electronic device encapsulating effect of the encapsulating film can be enhanced and, at the same time, the encapsulation process can be simplified.

Other than the above-described layers, the encapsulating film can also be used by combining it with another constituent element of electronic devices, such as a color filter or optical film.

Various methods can be used to produce the various types of encapsulating film by processing the adhesive encapsulating composition into an adhesive film 120. Examples of the methods that are applicable include, but are not limited to, screen printing methods, spin coating methods, doctor blade methods, calendar methods, extrusion-forming methods using a T-die, or the like. In some methods, a lamination method is used that includes forming an adhesive film on a backing 110, serving as a release film, and then transferring the adhesive film to a component of the EL device. The thickness of the encapsulating composition layer formed into the adhesive film is not generally limited and can be from about 5 to 200 μm, from about 10 to 100 μm, or from about 25 to 100 μm. The same processing methods used to form the adhesive layer 120 can be used to form the gas-barrier film 130 or the trapping agent 140.

An organic EL device may have various constitutions known to those of skill in the art. The organic EL device can comprise a stacked body comprising a pair of opposing electrodes, an anode and a cathode, and a light-emitting unit having at least an organic light-emitting layer disposed between those electrodes. The stacked body is encapsulated by an adhesive encapsulating composition or an encapsulating film.

In the organic EL device, the stacked body comprising two electrodes and a light-emitting unit disposed between those electrodes can have various constitutions as understood from the fact that, for example, one light-emitting unit is incorporated in some cases or a combination of two or more light-emitting units is also sometimes incorporated. The constitution of the stacked body is described below.

In the organic EL device, the stacked body is supported on a substrate. The substrate generally comprises a hard material, for example, an inorganic material or a resin material. Exemplary inorganic materials include yttria-stabilized zirconia (YSZ), glass, and metal. Exemplary resin materials include polyesters, polyimides, and polycarbonates. The substrate is not limited in its shape, structure, dimension or the like. The substrate often has a plate shape. The substrate may be transparent, colorless, translucent, or opaque. In one embodiment, a moisture permeating-inhibiting layer (gas-barrier layer) or the like may be provided on the substrate.

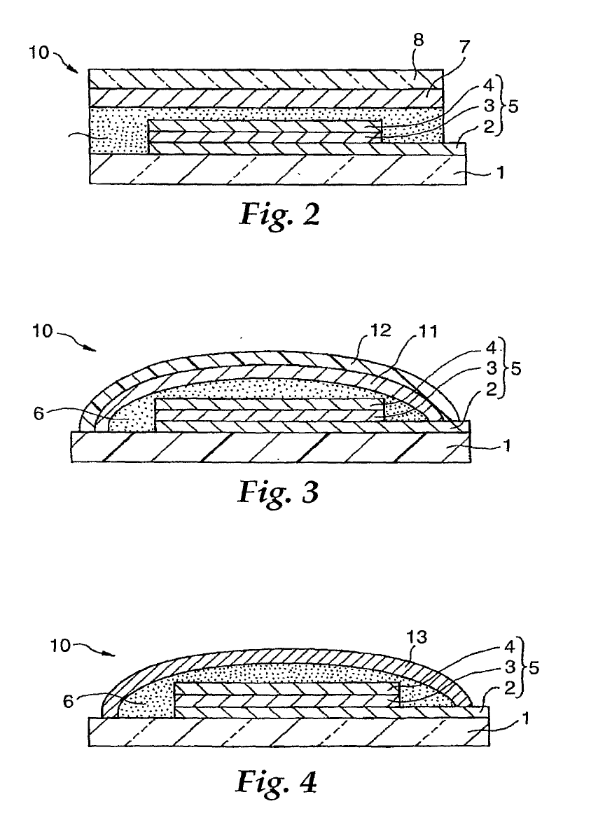

The substrate, comprising the above-described hard material, is useful in an organic EL device where, as shown in FIG. 2, a stacked body is disposed on a substrate comprising a hard material. The stacked body is encapsulated with an adhesive encapsulating composition or an encapsulating film. The outermost layer is covered by a sealing cap, which usually comprises a hard material. Such a device is also referred to an organic EL device with a “cap structure”. This organic EL device can be fabricated in a thin and compact manner because a space for housing the stacked body is not necessary.

In an organic EL device, as described below by referring to FIG. 3, the substrate can comprise a flexible material. This organic EL device is an organic EL device having a so-called “capless structure”, where a stacked body is disposed on a substrate generally comprising a flexible material. The stacked body is encapsulated with an adhesive encapsulating composition or an encapsulating film. The outermost layer is covered with a protective film. In one embodiment, a protective film having a water vapor-barrier property (sometimes also called a gas-barrier layer or a gas-barrier film) is utilized. The flexible material suitable for the substrate can be a resin material, for example, a fluorine-containing polymer (for example, polyethylene trifluoride, polychlorotrifluoroethylene (PCTFE), a copolymer of vinylidene fluoride (VDF) and chlorotrifluoroethylene CTFE), a polyimide, a polycarbonate, a polyethylene terephthalate, an alicyclic polyolefin or an ethylene-vinyl alcohol copolymer. The substrate can be coated with a gas-barrier inorganic film containing an inorganic material such as SiO, SiN or DLC (Diamond-like Carbon). The inorganic film can be formed using a method such as vacuum vapor deposition, sputtering and plasma CVD (Chemical Vapor Deposition). Other materials not explicitly stated herein may also be used. Because this embodiment of the organic EL device does not require a space for housing the stacked body, thin and compact fabrication can be realized. Also, since a sealing cap is not required, lightweight fabrication can be achieved. Furthermore, because the substrate is flexible to allow for deformation of the EL device, the device can be easier to install, can be installed in more places, and can be used in flexible displays.

The stacked body in the organic EL device comprises a pair of opposing electrodes (i.e., an anode and a cathode) and a light-emitting unit disposed between those electrodes. The light-emitting unit may have various layered structures containing an organic light-emitting layer, which is described below.

The anode generally functions to supply a hole to the organic light-emitting layer. Any known anode material can be used. The anode material generally has a work function of 4.0 eV or more, and suitable examples of the anode material include, but are not limited to, a semiconducting metal oxide such as tin oxide, zinc oxide, indium oxide and indium tin oxide (ITO); a metal such as gold, silver, chromium and nickel; and an organic electrically conducting material such as polyaniline and polythiophene. The anode usually includes a film formed, for example, by vacuum vapor deposition, sputtering, ion plating, CVD or plasma CVD. In some applications, the anode can be subjected to patterning by etching or the like. The thickness of the anode can be varied over a wide range and can generally be from about 10 nm to 50 μm.

The cathode used in conjunction with the anode generally functions to inject an electron into the organic light-emitting layer. Any known cathode materials can be used. The cathode material generally has a work function of 4.5 eV or less, and suitable examples of the cathode material include, but are not limited to, alkali metals such as Li, Na, K and Cs; alkaline earth metals such as Mg and Ca; and rare earth metals such as gold, silver, indium and ytterbium. The cathode usually includes a film formed, for example, by vacuum vapor deposition, sputtering, ion plating, CVD or plasma CVD. In some applications, the cathode can be subjected to patterning by etching or the like. The thickness of the cathode may be varied over a wide range but can be from about 10 nm to 50 μm.

The light-emitting unit positioned between the anode and the cathode may have various layer structures. For example, the light-emitting unit may have a single layer structure comprising only an organic light-emitting layer or may have a multilayer structure such as organic light-emitting layer/electron transport layer, hole transport layer/organic light-emitting layer, hole transport layer/organic light-emitting layer, hole transport layer/organic light-emitting layer/electron transport layer, organic light-emitting layer/electron transport layer/electron injection layer, and hole injection layer/hole transport layer/organic light-emitting layer/electron transport layer/electron injection layer. Each of these layers is described below.

The organic light-emitting layer can comprise at least one light-emitting material and may optionally contain a hole transport material, an electron transport material or the like. The light-emitting material is not particularly limited and any light-emitting material commonly used in the production of an organic EL device may be utilized.

The light-emitting material can include a metal complex, a low molecular weight fluorescent coloring material, or a fluorescent polymer compound. Suitable examples of the metal complex include, but are not limited to, tris(8-quinolinolate)aluminum complex (Alq3), bis(benzoquinolinolate)beryllium complex (BeBq2), bis(8-quinolinolate)zinc complex (Znq2), and phenanthroline-based europium complex (Eu(TTA)3(phen)). Suitable examples of the low molecular weight fluorescent coloring material include, but are not limited to, perylene, quinacridone, coumarin and 2-thiophenecarboxylic acid (DCJTB). Suitable examples of the fluorescent polymer compound include, but are not limited to, poly(p-phenylenevinylene) (PPV), 9-chloromethylanthracene(MEH-PPV), polyfluorene (PF), and polyvinyl carbazole (PVK).

The organic light-emitting layer can be formed from light-emitting materials such as those discussed above using any suitable method. For example, the organic light-emitting layer can be formed using a film-forming method such as vacuum vapor deposition or sputtering. The thickness of the organic light-emitting layer is not particularly limited but can generally be from about 5 to 100 nm.

The organic light-emitting unit may include a hole transport material. The hole transport material generally functions to inject a hole from the anode, transport a hole, or block an electron injected from the cathode. Suitable examples of hole transport materials include, but are not limited to, N,N′-diphenyl-N,N′-di(m-tolyl)benzidine (TPD), N,N,N′,N′-tetrakis(m-tolyl)-1,3-phenylenediamine (PDA), 1,1-bis[4-[N,N-di(p-tolyl)amino]phenyl]cyclohexane (TPAC), and 4,4′,4″-tris[N,N′,N″-triphenyl-N,N′,N″-tri(m-tolyl)]amino]-phenylene (m-MTDATA). The hole transport layer and the hole injection layer each may be formed by using a film-forming method such as vacuum vapor deposition and sputtering. The thickness of these layers is not particularly limited but can generally be from about 5 to 100 nm.

The organic light-emitting unit can include an electron transport material. The electron transport material can function to transport an electron, or block a hole injected from the anode. Suitable examples of electron transport material include, but are not limited to, 2-(4-tert.-butylphenyl)-5-(4-biphenylyl)-1,3,4-oxadiazole (PBD); and 3-(4-tert.-butylphenyl)-4-phenyl-5-(4-biphenylyl)-1,2,4-triazole (TAZ). The electron transport layer and the electron injection layer each may be formed using a film-forming method such as vacuum vapor deposition and sputtering. The thickness of these layers is not particularly limited but can generally be from about 5 to 100 nm.

In an organic EL device, the above-described stacked body is encapsulated with an adhesive encapsulating composition or an encapsulating film. An adhesive encapsulating composition or an encapsulating film is generally used in the form of an encapsulant layer entirely covering the exposed surface of the stacked body disposed on the substrate. The details of an adhesive encapsulating composition or an encapsulating film and encapsulating methods are as described above.

In an organic EL device, an adhesive encapsulating composition or an encapsulating film has adhesive properties by itself. Laminating the encapsulating film does not require an additional adhesive layer. That is, additional laminating adhesives can be omitted and the simplification and reliability of the production process can be enhanced. Furthermore, unlike conventional techniques, an encapsulation space does not remain in the device because the stacked body is covered with an encapsulant layer. Without the encapsulation space, moisture permeation is reduced, thereby preventing degradation of the device characteristics while maintaining compact and thin devices. Further, an adhesive encapsulating composition or an encapsulating film can be transparent in the visible region (380 to 800 nm) of the spectrum. Because the encapsulating film typically has an average transmittance of not less than 80% or not less than 90%, the encapsulating film does not substantially deteriorate the light-emission efficiency of the organic EL device.

On the outside of the stacked body, a passivation film can be disposed to protect the top and bottom of the stacked body. The passivation film can be formed of an inorganic material such as SiO, SiN, or DLC by using a film-forming method such as, for example, vacuum vapor deposition and sputtering. The thickness of the passivation film is not particularly limited but can generally be about 5 to 100 nm.

On the outside of the stacked body, a material capable of absorbing moisture and/or oxygen or a layer thereof can also be disposed. Such a layer can be disposed at any position as long as the desired effect is provided. Such a material or layer is sometimes called a desiccant, moisture absorbent, desiccant layer or the like but is referred to herein as a “trapping agent” or a “trapping layer”.

Examples of the trapping agent include, but are not limited to, a metal oxide such as calcium oxide, magnesium oxide, and barium oxide; a sulfate such as magnesium sulfate, sodium sulfate, and nickel sulfate; and an organic metal compound such as aluminum oxide octylate.

As described in another patent application separately filed by the present inventors (Japanese Patent Application No. 2005-057523), a trapping agent that can be utilized herein includes a polysiloxane compound having a group represented by formula (I) at the terminal of the main chain or in a side chain:

-MXₘYₙ (I)

wherein M is a divalent or a higher valent metal atom such as B, or P═O; X is hydrogen or a substituted or unsubstituted alkyl, alkenyl or alkoxy group; Y is a substituted or unsubstituted alkoxy, siloxy or carboxyl group or a diketolate; m is a number from 1 to 3; and n is a number from 0 to 2.

In one embodiment, the trapping agent compound can be represented by formula (II):

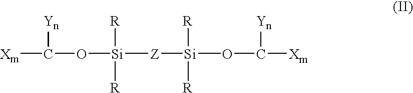

wherein R may be the same or different and are each independently selected from hydrogen, a substituted or unsubstituted linear or alicyclic alkyl or alkenyl group having a carbon number of 1 to 20, or a substituted or unsubstituted aryl group having a carbon number of 1 to 10; Z is a divalent linking group such as polysiloxane; X may be the same or different, and are each independently hydrogen, or a substituted or unsubstituted alkyl, alkenyl or alkoxy group; Y may be the same or different, and are each independently a substituted or unsubstituted alkoxy, siloxy or carboxyl group or a diketolate; m is a number from 1 to 3; and n is a number from 0 to 2.

In one embodiment of the trapping agent compound of formula (II), R may be the same or different, and are each independently selected from hydrogen, a methyl group, an ethyl group, a butyl group, a hexyl group, an octyl group, a phenyl group or a vinyl group. In one embodiment, R is a methyl group or a phenyl group.

In one embodiment of the trapping agent compound of formula (II), Z is polydimethylsiloxane, polydiphenylsiloxane, polyphenylmethylsiloxane or polytrifluoropropylmethylsiloxane. In another embodiment Z is polydimethylsiloxane or polyphenylmethylsiloxane. In practice, a polysiloxane having a silanol group at the terminal is commercially available, for example, from GE Toshiba Silicones under the trade designations YF3800, YF3057, YF3897 and YF3804. The molecular weight thereof may be appropriately selected according to the physical properties of the composition but can generally be from about 200 to 3,000,000 g/mole.

In one embodiment of formula II, M is independently selected from Al, B, Ti or Zr. In yet another embodiment, M is independently selected from Al or Ti.

In one embodiment of formula II, X is an alkyl group such as a methyl group, ethyl group, propyl group, butyl group, hexyl group and octyl group; an alkoxy group such as a methoxy group, ethoxy group, butoxy group, hexyloxy group, cyclohexyloxy group, octyloxy group, 2-ethylhexyloxy group, decyloxy group, lauryloxy group, myristyloxy group, cetyloxy group, isostearyloxy group, 2-octyldodecyl group, isoborneoxy group and cholesteroxy group; a polyoxyalkylene monoalkyl ester or ether oxy group such as polyoxyethylene monolauryl ester oxy group, polyoxyethylene monomethyl ether oxy group, polyoxypropylene monobutyl ether oxy group, polytetrahydrofuran monomethyl ether oxy group; or an alkoxyl group having a polydimethylsiloxane skeleton. In another embodiment, X is an octyl group, an n-octyloxy group, a 2-ethylhexyloxy group, an isostearyloxy group, a 2-octyldodecyloxy group, a polyoxyethylene monomethyl ether oxy group, a polyoxypropylene monobutyl ether oxy group, a polytetrahydrofuran monomethyl ether oxy group, or an alkoxyl group having a polydimethylsiloxane skeleton. Specific examples of the alkoxyl group having a polydimethylsiloxane skeleton include, but are not limited to, materials commercially available from Chisso Corp. under the trade designation FM2221, FM2241 and FM2245.

In one embodiment of formula (II), Y can be used for adjusting the curing rate and the compatibility between compositions before and after curing. In one embodiment, Y is an alkylcarboxyl group. In another embodiment, Y is 2-ethylhexyl carboxylate, isostearyl carboxylate, stearyl carboxylate, cyclohexane carboxylate or naphthene carboxylate.

The trapping agent compound of formula (II) has a metal moiety (-MX—) and a silanol group moiety (—Si—O—). The metal moiety can swiftly react with water or oxygen, and the silanol group moiety can adjust the reactivity, fluidity, flexibility and compatibility of the compound. Accordingly, this trapping agent compound can be advantageously used as a moisture scavenger in an organic EL device or other devices susceptible to the effect of moisture. Furthermore, this trapping agent composition can react not only with moisture but also with oxygen and therefore, can also be advantageously used as an oxygen scavenger. In addition, a film formed of this trapping agent is transparent and therefore, can be easily arranged in the stacked body of an organic EL device. Also, the film has flexibility and therefore, can advantageously be used in a flexible display. An organic EL device including this trapping agent compound can be disposed as a moisture scavenger, can minimize deterioration due to moisture or oxygen, and can maintain the light-emitting characteristics over a long period of time.

The trapping layer may be formed by any method known to those of skill in the art based on the kind of trapping agent. For example, the trapping layer can be formed by attaching a film having a trapping agent dispersed therein by using a pressure sensitive adhesive, spin-coating a trapping agent solution, or a film-forming method such as vacuum vapor deposition and sputtering. The thickness of the trapping layer is not limited but can generally be from about 5 to 500 μm.

In addition to the above-described constituent elements, an organic EL device may additionally comprise various constituent elements known to those of skill in the art.

If a full color device is desired, an organic EL device employing a white light-emitting portion can be used in combination with a color filter. Such combination would not be necessary in a three-color light emitting method. Also, in the case of an organic EL device employing a color conversion method (CCM), a color filter for correction of color purity can be used in combination.

As described above, the organic EL device may have a sealing cap (sometimes called a sealing plate or the like) as the outermost layer. The sealing cap can usually be formed of a hard material, typically, glass or a metal.

According to an alternate method, the organic EL device may have a protective film as the outermost layer. This protective film can include a protective film having a water vapor-barrier or oxygen-barrier property and is sometimes called a “gas-barrier film” or a “gas-barrier film layer”. The gas-barrier film layer may be formed of various materials having water vapor-barrier properties. Suitable materials include, but are not limited to, a polymer layer including a fluorine-containing polymer (e.g., polyethylene trifluoride, polychlorotrifluoroethylene (PCTFE), polyimide, polycarbonate, polyethylene terephthalate, alicyclic polyolefin and an ethylene-vinyl alcohol copolymer; a stacked body of such polymer layers or a layer obtained by coating such a polymer layer with an inorganic thin film (e.g., silicon oxide, silicon nitride, aluminum oxide, diamond-like carbon) by using a film-forming method (e.g., sputtering), may be used. The thickness of the gas-barrier film layer may be varied over a wide range but can generally be from about 10 to 500 μm.

As described above, an organic EL device may have various forms and the layered structure thereof may also be variously changed. More specifically, FIG. 2 shows one example of an organic EL device having a cap structure. The organic EL device 10 comprises a substrate formed of a hard material (in FIG. 2, a glass substrate) 1, and a stacked body 5 undertaking the light-emitting function disposed thereon. The stacked body 5 comprises, as shown in FIG. 2, an anode 2, a light-emitting unit 3 and a cathode 4. The anode 2 may be formed from, for example, an indium tin oxide (ITO) transparent electrode. The light-emitting unit 3 contains an organic light-emitting layer (for example, a quinolinol-aluminum complex) and, as described above, may have various layer structures. The cathode 4 may be formed of, for example, a MgAg alloy. The periphery of the stacked body 5 is encapsulated by an encapsulant layer 6 comprising an adhesive encapsulating composition or an encapsulating film to prevent adverse effects on the device characteristics and at the same time, achieve compact fabrication of the device. The EL device shown in FIG. 2 is a white light EL device and therefore, a color filter 7 is provided above the stacked body 5. Furthermore, the outermost layer of the EL device is covered with a sealing cap 8. In FIG. 2, a glass plate is used as the sealing cap 8. Although not shown, this organic EL device may comprise other layers generally used in conventional organic EL devices. One example thereof is a trapping layer disposed near the stacked body 5.

FIG. 3 shows one example of an organic EL device having a capless structure. The organic EL device 10 of this example is designed to provide a flexible display and therefore, comprises a substrate 1 formed of a flexible polymer film, and a stacked body 5 is further provided thereon. The stacked body 5 comprises an anode 2, a light-emitting unit 3, and a cathode. The anode 2, the light-emitting unit 3, and the cathode 4 each may be formed of various materials as described above by referring to FIG. 2. The periphery of the stacked body 5 is encapsulated by an encapsulant layer 6 comprising an adhesive encapsulating composition or an encapsulating film. Furthermore, a trapping layer 11 can be formed on the encapsulant layer 6. The trapping layer 11 can be formed of, for example, a trapping agent composition of formula (II). In the EL device shown, the outermost layer is covered with a gas-barrier film layer 12 comprising a silica-deposited polyethylene terephthalate film. Incidentally, in the organic EL device shown in FIG. 3, the encapsulant layer 6, the trapping layer 11 and the gas-barrier film layer 12 can also be formed at the same time by using an encapsulating film as shown in FIG. 1(c).

An organic EL device can be utilized as an illumination or a display means in various fields. Examples of applications include illumination devices used in place of a fluorescent lamp; display devices of a computer device, television receiver; DVD (digital video disc), audio instrument, measurement hardware, cellular phone, PDA (personal digital assistance), panel or the like; backlight; and light source array of a printer or the like.

### EXAMPLES

The present invention is described below by referring to Examples, but the present invention is of course not limited by these Examples.

### Example 1

### Production of an Adhesive Encapsulating Film

15 Parts by weight of a polyisobutylene resin (OPANOL B100 from BASF AG with a viscosity average molecular weight of 1,110,000 g/mole) and 10 parts by weight of a hydrogenated petroleum resin (IMARV P-100 from Idemitsu Kosan Co., Ltd., softening point: 100° C.) were dissolved in toluene to prepare a 15 wt % resin solution. The obtained resin solution was coated on a 38 μm-thick release-treated PET film and dried in an oven at 100° C. for 20 minutes. The obtained film including a pressure sensitive adhesive was laminated on a 25 μm-thick release-treated PET (polyethylene terephthalate) film to produce a pressure sensitive adhesive sheet. In this way, a transparent film (adhesive encapsulating film) having a pressure sensitive adhesive thickness of 50 μm was obtained. The characteristics of the obtained encapsulating film were evaluated by an adhesion test, measurements of moisture permeability, and visible light transmittance according to the following procedures.

### Adhesion Test:

The encapsulating film (50 mm (length)×20 mm (width)) was laminated on the end of a piece of aluminum foil (100 mm (length)×20 mm (width)×0.05 mm (thickness)), produced by Sumikei Aluminum-Foil Co., Ltd., part number: “SA50”), and the obtained laminate was further laminated on a glass plate (76 mm (length)×26 mm (width)×1.2 mm (thickness), produced by Matsunami Glass Ind., Ltd., trade name: “Micro-Slide Glass S-7224”). The resulting stacked body was subjected to measurement of the peel force (adhesive force) when the film was peeled off at 900 along the length of the aluminum foil. The pulling rate was 100 mm/min. The measurement was performed twice on each sample, and an average value of peel forces at respective measurements was determined. As shown in Table 2 below, the adhesive force was 16 N/25 mm.

### Measurement of Moisture Permeability:

A 100 μm-thick encapsulating film produced by the above-described method was used as a sample for measurement. The measurement of moisture permeability was performed by a cup method according to JIS Z0204. The measurement conditions were 60° C., a relative humidity of 90% (a constant-temperature constant-humidity vessel was used), and a measurement time of 24 hours. As shown in Table 2 below, the moisture permeability was 11 g/m²·24 h and were revealed to be a low value.

### Measurement of Visible Light Transmittance:

A 50 μm-thick encapsulating film produced by the above-described method was used as a sample for measurement. The measurement of transmittance was performed by using a spectrophotometer, part number “U-4100”, manufactured by Hitachi. When an average value of transmittances at a wavelength region of 380 to 800 nm was determined, as shown in Table 2 below, a high transmittance of 90% or more was exhibited. This revealed that this encapsulating film can be used while transmitting light.

### Examples 2 to 15

Adhesive encapsulating films were produced by using the method described in Example 1, but in these Examples, the resin components were changed as shown in Table 1 below (values shown in Table 1 are weight %). The details of the resin components used in these Examples are as follows.

Polymer 1: polyisobutylene (OPANOL B100, BASF AG, Mv equal to 1,110,000 g/mole)

Polymer 2: polyisobutylene (OPANOL B200, BASF AG, Mv equal to 4,000,000 g/mole)

Compound 1: hydrogenated C5-C9 hydrocarbon resin (IMARV P-100, Idemitsu Kosan Co., Ltd., softening point: 100° C.)

Compound 2: hydrogenated C5-C9 hydrocarbon resin (IMARV P-140, Idemitsu Kosan Co., Ltd., softening point: 140° C.)

Compound 3: hydrogenated alicyclic hydrocarbon resin (ESCOREZ 5380, Exxon Mobil Co., Ltd., softening point: 85° C.)

Compound 4: hydrogenated alicyclic hydrocarbon resin (ESCOREZ 5300, Exxon Mobil Co., Ltd., softening point: 105° C.)

Compound 5: hydrogenated alicyclic hydrocarbon resin (ESCOREZ 5340, Exxon Mobil Co., Ltd., softening point: 137° C.)

Compound 6: hydrogenated alicyclic hydrocarbon resin (ESCOREZ 5400, Exxon Mobil Co., Ltd., softening point: 102° C.)

Compound 7: hydrogenated terpene resin (CLEARON P85, Yasuhara Chemical, softening point: 85° C.)

Compound 8: hydrogenated terpene resin (CLEARON P125, Yasuhara Chemical, softening point: 125° C.)

Compound 9: hydrogenated hydrocarbon aromatic modified resin (ESCOREZ 5600, Exxon Mobil Co., Ltd., softening point: 102° C.)

Compound 10: hydrogenated C₅-C₉ hydrocarbon resin (IMARV S100, Idemitsu Kosan Co., Ltd., softening point: 100° C.)

Compound 11: hydrogenated terpene aromatic modified resin (CLEARON K4090, Yasuhara Chemical, softening point: 90° C.)

Compound 12: polyisobutylene (GLISSOPAL V1500, BASF AG, Mv=2,500)

Compound 13: polyisobutylene (TETRAX 3T, Nippon Petrochemicals Co., Ltd., Mv=30,000)

### Characteristic Test of Encapsulating Film

For evaluating the characteristics of the encapsulating films obtained herein, an adhesion test, measurements of moisture permeability, and visible light transmittance were performed according to the procedures described in Example 1. The results are shown in Table 2 below.

As seen from Table 2, in Examples 2 to 15 where polyisobutylene is added to a hydrogenated hydrocarbon resin, the resin can be shaped into a film form while still maintaining the low moisture permeability, and an adhesive force of 15 N/25 mm or more. Furthermore, the film has high transparency in the visible light region and therefore, can be used where transparency is desired.

### Comparative Example 1

The procedure described in Example 1 was repeated except that an epoxy resin adhesive XNR5516HV that is commercially available from Nagase ChemteX Corp. was used for preparation of the encapsulating film. Data from the manufacturer shows that the adhesive is a photocurable liquid adhesive having a viscosity of 370 Pa, the water absorption percentage is 1% and the Tg after curing is 100° C. or more and it displays cracks when bent. Since a filler is added in this adhesive, the film is white without transparency and cannot be used for a top emission structure where the light is emitted through the adhesive. Furthermore, the moisture permeability is 16 g/m²/24 h and is poor as compared with Examples 1 to 15. Also, since it is cured using ultraviolet irradiation at 6,000 mJ/cm² and after curing is kept at 80° C. for 1 hour, the device is apparently damaged due to light or heat and the long curing time gives rise to bad productivity.

TABLE 1

| | Polymer | | Compound | | | | | | | | | | | | |
|---|---|---|---|---|---|---|---|---|---|---|---|---|---|---|---|
| | 1 | 2 | 1 | 2 | 3 | 4 | 5 | 6 | 7 | 8 | 9 | 10 | 11 | 12 | 13 |
| Example 1 | 60 | | 40 | | | | | | | | | | | | |
| Example 2 | 70 | | | 30 | | | | | | | | | | | |
| Example 3 | 60 | | | | 40 | | | | | | | | | | |
| Example 4 | 60 | | | | | 40 | | | | | | | | | |
| Example 5 | 70 | | | | | | 30 | | | | | | | | |
| Example 6 | 80 | | | | | | 20 | | | | | | | | |
| Example 7 | 60 | | | | | | | 40 | | | | | | | |
| Example 8 | | 60 | | | | | | | 40 | | | | | | |
| Example 9 | 60 | | | | | | | | | 40 | | | | | |
| Example 10 | | 40 | | | | | 40 | | | | | | | 20 | |
| Example 11 | 60 | | | | | | | | | | 40 | | | | |
| Example 12 | 60 | | | | | | | | | | | 40 | | | |
| Example 13 | 60 | | | | | | | | | | | | 40 | | |
| Example 14 | 50 | | | | | | 30 | | | | | | | | 20 |
| Example 15 | 30 | | | | | | 70 | | | | | | | | |

TABLE 2

| | Adhesive Force | Moisture | Transmittance (% T) |
|---|---|---|---|
| | (N/25 mm) | Permeability | (average at a wavelength of |
| | (100 mm/min) | (g/m² · 24 h) | 380 to 800 nm) |
| Example 1 | 16 | 13 | 92 |
| Example 2 | 21 | 13 | 92 |
| Example 3 | 18 | 14 | 92 |
| Example 4 | 16 | 11 | 92 |
| Example 5 | 20 | 12 | 92 |
| Example 6 | 17 | 12 | 90 |
| Example 7 | 15 | 13 | 92 |
| Example 8 | 20 | 14 | 92 |
| Example 9 | 15 | 13 | 93 |
| Example 10 | 20 | 16 | 92 |
| Example 11 | 18 | 17 | 92 |
| Example 12 | 8 | 14 | 87 |
| Example 13 | 6 | 19 | 86 |
| Example 14 | 6 | 6 | 91 |
| Example 15 | 22 | 10 | 97 |
| Polymer 1 | — | 15 | 96 |
| Polymer 2 | — | 25 | 96 |

In Table 2, the physical properties of polyisobutylene resin (Polymers 1 and 2) are also shown.

As understood from the measurement results in Table 2, the adhesive encapsulating film has sufficiently high adhesive force and low moisture permeability. Furthermore, since the film is thermoplastic, processes that can damage the organic EL device, i.e. beating and ultraviolet irradiation, are not required during lamination, so that the film can be advantageously used for the encapsulation of an organic EL device. This is shown in Example 16 below.

### Example 16

### Production of Organic EL Device

In this Example, an organic EL device 10 having the layer structure shown in FIG. 4 was produced. As the glass substrate, a glass substrate 1 with an ITO (indium tin oxide) film 2 (manufactured by Sanyo Vacuum Industries Co., Ltd., ITO film thickness: 150 μm, sheet resistance: <14 Ω/square, glass thickness: 0.7 mm, outside dimension: 40 mm×40 mm) was prepared. The ITO film 2 was patterned by photolithography to form an ITO electrode pattern 2 on the substrate 1.

The surface of the substrate 1 with the patterned ITO electrode was washed by solvent washing. Thereafter, an organic light-emitting layer 3 and a metal electrode layer 4 were sequentially film-formed on the ITO electrode 2 by vacuum vapor deposition to form a stacked body 5. During the vacuum vapor deposition, the vapor deposition rate and the vapor deposition thickness were monitored by a film thickness sensor utilizing a quartz oscillator (IC6000, manufactured by INFICON) The background pressure of the vacuum chamber was about 1×10⁻⁷ torr.

The organic light-emitting layer consisted of the following three kinds of organic low molecular weight substances and had a total film thickness t of 130 nm. First, a 15 nm-thick copper phthalocyanine (CuPc) was vapor-deposited as a hole injection layer on the ITO electrode 2. Next, a 55 nm-thick bis([N-(1-naphthyl)-N-phenyl]benzidine (NPD) was vapor-deposited as a hole transport layer on the CuPc. Subsequently, a 60 nm-thick tris(8-quinolinolate)aluminum (III) (Alq₃) was vapor-deposited as an electron transport and light-emitting layer on the NPD. For all of these organic materials, the vapor deposition rate was about 3 Å/s. The organic materials used here were those produced by Nippon Steel Chemical Co., Ltd.

Furthermore, on the Alq₃ film-formed as above, a metal electrode layer 4 was film-formed by vacuum vapor deposition. The metal electrode layer 4 consisted of the following two kinds of inorganic materials and had a total film thickness t of 101 nm. First, a 1 nm-thick lithium fluoride (produced by Furuuchi Chemical Corp., 99.99%) was vapor-deposited as an electron injection layer. Next, a 100 nm-thick aluminum layer (produced by Kojundo Chemical Lab. Co., Ltd.) was vapor-deposited as an electrode metal on the lithium fluoride. The vapor deposition rate was about 0.3 Å/s for lithium fluoride and about 5 Å/s for aluminum.

An adhesive resin composition having the composition for use as a sealing cap and an encapsulant layer of Example 6 was coated on a copper foil (thickness: 25 μm, rolled) to obtain a copper foil with a 50 μm-thick adhesive layer.

The obtained copper foil was dried under heating for 10 minutes on a hot plate heated to 120° C. in an inert atmosphere of nitrogen gas deprived of moisture and oxygen as much as possible, whereby the moisture in the composition was almost completely removed. After the copper foil was left standing until it reached room temperature, the adhesive layer of the copper foil was opposed to the stacked body 5 produced in the previous step and laminated. As shown in FIG. 4, an organic EL device 10 where the stacked body 5 was sequentially covered with an encapsulant layer 6 and with a sealing cap 13 was obtained.

A direct current voltage of about 9 V was applied to the organic EL device 10 prepared above, and the light-emitting part was observed, as a result, a dark spot was not found. This reveals that, unlike a conventional adhesive containing moisture, which is difficult to remove, the adhesive resin composition is almost free of moisture and the composition itself does not serve to deteriorate the device. Furthermore, this organic EL device was verified to stably emit light even after storage in air at a temperature of 25° C. and a humidity of 50% for 1,000 hours.

### Example 17-21

### Preparation of an Adhesive Encapsulating Film

40 grams of polyisobutylene resin (BASF AG, OPANOL B100, Mv=400000), 50 grams of hydrogenated hydrocarbon resin (Exxon Mobil Co., Ltd., ESCOREZ 5340, Softening Point 137° C.), 10 grams of UV-curable acrylate resin (Shin-Nakamura Chemical Industry, Co., Ltd., A-DCP), and 1 gram of photo polymerization initiator (Ciba Specialty Chemicals, Co., Ltd., IRGACURE 184) were dissolved in toluene to provide a 25 weight percent solids solution as Example 17. This solution was coated on a siliconized PET film (Teijin-DuPont Co., Ltd. A31 38 μm) (referred to below as PET 1) using a knife coater. Next, it was dried at 100° C. for 30 minutes and then laminated to another siliconized PET film (Teijin-DuPont Co., Ltd. A71 38 μm) (referred to below as PET 2). The thickness of the adhesive layer was 50 μm. Examples 18-21 were prepared in the same way using the components in Table 3.

### Example 22

Example 22 was prepared by dissolving 70 g polyisobutylene (BASF AG, OPANOL B50, Mv=400,000), and 30 grams hydrogenated hydrocarbon resin (ESCOREZ 5340, Exxon Mobil Co., Ltd., Softening Point: 137° C.) in toluene to prepare a 25% weight solution. This solution was used to create an adhesive layer as discussed above in Example 17-21

TABLE 3

| | P3 | P4 | C14 | C15 | C16 | C17 | C18 | C19 |
|---|---|---|---|---|---|---|---|---|
| | (g) | (g) | (g) | (g) | (g) | (g) | (g) | (g) |
| Example 17 | 40 | | 10 | | | 50 | 1 | |
| Example 18 | 30 | | 10 | | | 60 | 1 | |
| Example 19 | 35 | | 15 | | | 50 | 1 | |
| Example 20 | 40 | | | 10 | | 50 | 1 | |
| Example 21 | 40 | | | | 10 | 50 | | 1 |
| Example 22 | | 70 | | | | 30 | | |

P3: Polymer 3 - polyisobutylene (OPANOL B100, BASF AG, Mv = 1,110,000)
P4: Polymer 4 - polyisobutylene (OPANOL B50, BASF AG, Mv = 400,000)
C14: Compound 14 - tri-cyclodecane di-methanol diacrylates (A-DCP, Shin- Nakamur Chemical Industry, Co., Ltd.)
C15: Compound 15 - hydrogenated isoprene di-acrylates (SPIDA-S, Osaka Organic Chemical Industry, Co., Ltd.)
C16: Compound 16 - limonene dioxide (ATOFINA Chemicals)
C17: Compound 17 - hydrogenated cycloaliphatic hydrocarbon resin (ESCOREZ 5340, Exxon Mobil Co., Ltd., Softening Point = 137° C.)
C18: Compound 18 - photo radical polymerization initiator (IRGACURE 184, Ciba Specialty Chemicals, Co., Ltd.)
C19: Compound 19 -photo cationic polymerization initiator (WPI 113, Wako Chemical Co., Ltd.)

### Adhesion Test:

A 20 mm×50 mm portion of the adhesive film obtained above was cut and PET 1 was removed. Next the face (the surface of the adhesive film that was not backed with PET 2) was laminated to a 100 mm×20 mm Silica-deposited PET film (Mitsubishi Plastics Co., Ltd., Techbarrier H, 12 μm), and then PET 2 was removed and laminated to a 76 mm×26 mm glass plate (Matsunami Glass Co., Ltd., 1.2 mm thickness, S-7213). Next, the adhesive film was cured by UV irradiation (Fusion UV systems Japan Co., Ltd., F300S (H bulb), 50 mJ×20 times) through the glass plate. The 90′ peel test was done with a Tensilon machine (Toyo Baldwin Co., Ltd., RTM-100) at 20 mm/min (or the peel rate reported in Table 5) at 25° C. Peel data is reported as an average of two peel strength tests at 90° (Table 5).

Example 17 was also laminated onto a 100 mm×25 mm propylene plate in place of the glass plate. Example 22 was also laminated onto a 100 mm×20 mm portion of aluminum foil (Sumikei Aluminum-foil Co., Ltd., SA50, 50 μm that was used in place of the Silica-deposited PET film as discussed above. The film was evaluated as discussed below.

### Measurement of Moisture Permeability:

100 μm adhesive films obtained as above were cured by UV irradiation (Fusion UV systems Japan Co., Ltd., F300S(H bulb), 50 mJ×20 times). The moisture permeability was measured using the Cap Method in accordance with JIS Z0208. It was done at 60° C. and 90% relative humidity. The moisture permeability data reported is an average of two measurements (Table 4).

### Measurement of Transparency:

The transparency of the samples was measured with a Spectrophotometer U 4100 (Hitachi Ltd.). A 50 μm thick film prepared as above was used. Table 4 shows the average transparency in the wavelength region of 400 to 800 nm.

### Measurement of Retention Strength:

A 25 mm×25 mm portion of the adhesive films prepared above were cut and the PET 1 was removed. The face was then laminated to a 130 mm×25 mm silica-deposited PET film (Mitsubishi Plastics Co., Ltd., Techbarrier H, 12 μm). The PET 2, applied above, was removed and that face was laminated to a 76 mm×26 mm glass plate (Matsunami Glass Co., Ltd., 1.2 mm thickness, S-7213). The adhesive film was then cured through the glass plate by UV irradiation (Fusion UV systems Japan Co., Ltd., F300S(H bulb), 50 mJ/cm2×20 times. A1 kg lead weight was held at the end of the silica-deposited PET film, and then the elongation of adhesive film after 24 hours at 25° C. was measured as the retention strength. The retention strength reported in Table 4 is an average of three measurements.

TABLE 4

| | Permeability | % T | Retention Strength |
|---|---|---|---|
| | (g/m² · 24 h) | (@ 400 nm) | (mm) |
| Example 17 | 10 | 91 | 0 |
| Example 18 | 7 | 90 | 0 |
| Example 19 | 8 | 90 | 0 |
| Example 20 | 14 | 92 | 0 |
| Example 21 | 8 | 88 | 0 |
| Example 22 | 13 | 92 | 1.5 |

TABLE 5

| | Adhesion | | Peel rate |
|---|---|---|---|
| | (N/25 mm) | Substrate | (mm/min) |
| Example 17 | 34 | Glass-SiPET | 20 |
| | 22 | PP-SiPET | 10 |
| Example 18 | 7 | Glass-SiPET | 20 |
| Example 19 | 17 | Glass-SiPET | 10 |
| Example 20 | 26 | Glass-SiPET | 20 |
| Example 21 | 18 | Glass-SiPET | 10 |
| Example 22 | 23 | Glass-Al | 20 |
| | 13 | Glass-SiPET | 20 |

SiPET: Silica-deposited PET film
PP: Polypropylene plate
Al: Aluminum foil

1. An adhesive encapsulating composition for use in an electronic device, comprising:
a hydrogenated cyclic olefin-based polymer; and
a polyisobutylene resin.

2. The adhesive encapsulating composition according to of claim 1, further comprising a softening agent having a kinematic viscosity of 10,000 to 1,000,000 mm²/s.

3. The adhesive encapsulating composition of claim 1, wherein said cyclic olefin-based polymer is a dicyclopentadiene-based resin.

4. The adhesive encapsulating composition of claim 1, wherein said cyclic olefin-based polymer has a softening point of 50 to 200° C.

5. The adhesive encapsulating composition of claim 1, wherein said cyclic olefin-based polymer is from 20 to 70 wt % based on the entire weight of the adhesive encapsulating composition.

6. The adhesive encapsulating composition of claim 1, wherein said encapsulating composition is transparent in a visible region of the spectrum.

7. The adhesive encapsulating composition of claim 1, further comprising:
a photocurable resin; and
a photopolymerization initiator.

8. The adhesive encapsulating composition of claim 7, wherein the photocurable resin is from 5 to 50 wt % based on the entire weight of the adhesive encapsulating composition.

9. An encapsulating film comprising:
an adhesive film comprising the adhesive encapsulating composition comprising (1) a hydrogenated cyclic olefin-based polymer and (2) a polyisobutylene resin; and
a backing disposed on said adhesive film.

10. The encapsulating film of claim 9, wherein said adhesive film is transparent in a visible region of the spectrum.

11. The encapsulating film of claim 9, further comprising a gas-barrier film disposed on or above said adhesive film.

12. The encapsulating film of claim 9, further comprising a trapping agent disposed on or above said adhesive film or between said adhesive film and said backing.

13. An organic electroluminescence EL device comprising:
a pair of opposing electrodes;
a light-emitting unit having at least an organic light-emitting layer, which is disposed between said electrodes; and
an adhesive film comprising the adhesive encapsulating composition comprising (1) a hydrogenated cyclic olefin-based polymer and (2) a polyisobutylene resin, which is disposed on, above or around said light-emitting unit.

14. The organic electroluminescence device of claim 13, in which said adhesive film is transparent in a visible region of the spectrum.

15. The organic electroluminescence device of claim 13, further comprising:
a substrate on which said light-emitting unit is disposed, and
a sealing cap disposed on the outside of said light-emitting unit and said adhesive film.

16. The organic electroluminescence device of claim 13, wherein the device is flexible.

17. The organic electroluminescence device of claim 13, further comprising a trapping agent.

18. The organic electroluminescence device of claim 13, further comprising a gas-barrier film covering the outside of said light-emitting unit and said adhesive film.

19. The adhesive encapsulating composition of claim 1, wherein the polyisobutylene resin has a weight average molecular weight of 500,000 or more.
